(19) United States
(12) Patent Application Publication
(10) Pub. No.: US 2009/0322547 A1
(43) Pub. Date: Dec. 31, 2009

(54) COMPUTER ALERT SYSTEM AND METHOD FOR OBJECT PROXIMITY

(75) Inventor: WU-SHENG WEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/247,237

(22) Filed: Oct. 8, 2008

(30) Foreign Application Priority Data
Jun. 30, 2008 (CN) 200810302491.X

(51) Int. Cl. G08B 21/00; G06K 9/00

(52) U.S. Cl. 340/686.1; 382/106

(57) ABSTRACT

A computer alert system includes an image capture unit, an element detection unit, an autofocus unit, a calculation unit, a comparison unit and a warning unit. The image capture unit is capable of capturing a digital image of an object. The element detection unit is capable of detecting if a designated element of the object is in the captured digital image. The autofocus unit is capable of focusing on the designated element of the digital image. The calculation unit is capable of calculating a distance from the designated element of the object to the computer. The comparison unit is capable of determining if the calculated distance is acceptable. The alert unit capable of triggering an alert if the calculated distance is not acceptable. Furthermore, a computer alert method is employed by the computer alert system.

### BACKGROUND

1. Technical Field

The invention relates to computer alerts and, particularly, to a computer alert system and method for object proximity.

2. Description of the Related Art

Visually intense work, such as longtime of using computer screen, has been implicated as a contributing factor to myopia and other health problems. Therefore, it is recommended that computer users keep an acceptable distance from the computer monitors during use thereof. Additionally, it may be desired to monitor the proximity of other objects to a computer system.

Therefore, it is desirable to provide a computer alert system and method for object proximity, which can overcome the described limitations.

### BRIEF DESCRIPTION OF THE DRAWINGS

Many aspects of the present computer alert system and method for object proximity should be better understood with reference to the following drawings. The components in the drawings are not necessarily drawn to scale, the emphasis instead being placed upon clearly illustrating the principles of the present computer alert system and method for object proximity. Moreover, in the drawings, like reference numerals designate corresponding parts throughout the several views.

FIG. 1 is a functional block diagram of a computer alert system according to one embodiment.

FIG. 2 is a flowchart of a computer alert method according to another embodiment.

### DETAILED DESCRIPTION OF THE EMBODIMENTS

Embodiments of the present computer alert system and method will now be described in detail with reference to the drawings.

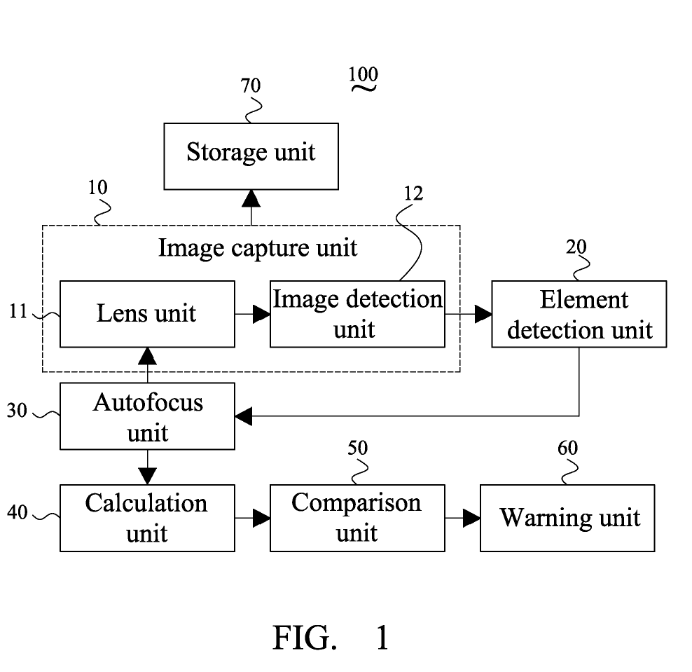

Referring to FIG. 1, a computer alert system 100 installed on a computer (not shown) includes an image capture unit 10, an element detection unit 20, an autofocus unit 30, a calculation unit 40, a comparison unit 50, and a warning unit 60.

The image capture unit 10 is configured for capturing a digital image and includes a lens unit 11 and an image detection unit 12. The lens unit 11 has a focusing lens and is configured for capturing an optical image of an object onto the image detection unit 12. The image detection unit 12 is configured for converting the optical image to a captured digital image. The image detection unit 12 may be a Charge Coupled Device (CCD) image sensor or Complementary Metal-Oxide-Semiconductor (CMOS) image sensor.

The element detection unit 20 is configured for locating and identifying a given element in the captured digital image, utilizing many different detection algorithms such as nerve network, nerve network plus fast Fourier transform, fuzzy plus nerve network, RGB normalized color, fuzzy color, principle component analysis, or algorithm template.

The autofocus unit 30 focuses the lens unit 11. In this embodiment, the autofocus unit 30 includes a step motor moving the lens unit 11 to perform focus operations.

The calculation unit 40 calculates the number of steps that the lens unit 11 moves from an origin to a focused position. The number of steps is calculated by a calculation formula, e.g., U=f*(ns+c+n)/(ns+c), where U is a distance from the focal point to the image capture unit 10, n is the number of steps calculated by the calculation unit 40, s is the step distance, c is a constant parameter, and f is focal length as a constant. It is to be noted that different variable values may be used with different step motors in acquiring the calculated distance from the focal point to the image capture unit 10. In this embodiment, the calculation unit 40 may be a counter.

The storage unit 70 is configured for storing a predetermined “safe” distance measurement preset by the manufacturer or user and the captured digital image. The storage unit 70 may be a semiconductor memory, such as an electrically-erasable programmable read-only memory (EEROM), or magnetic random access memory (MRAM).

The comparison unit 50 compares the calculated distance with the predetermined “safe” distance. If the calculated distance is less than the predetermined “safe” distance, it is determined that object proximity is unsafe and instructs the warning unit 60 to trigger an alert.

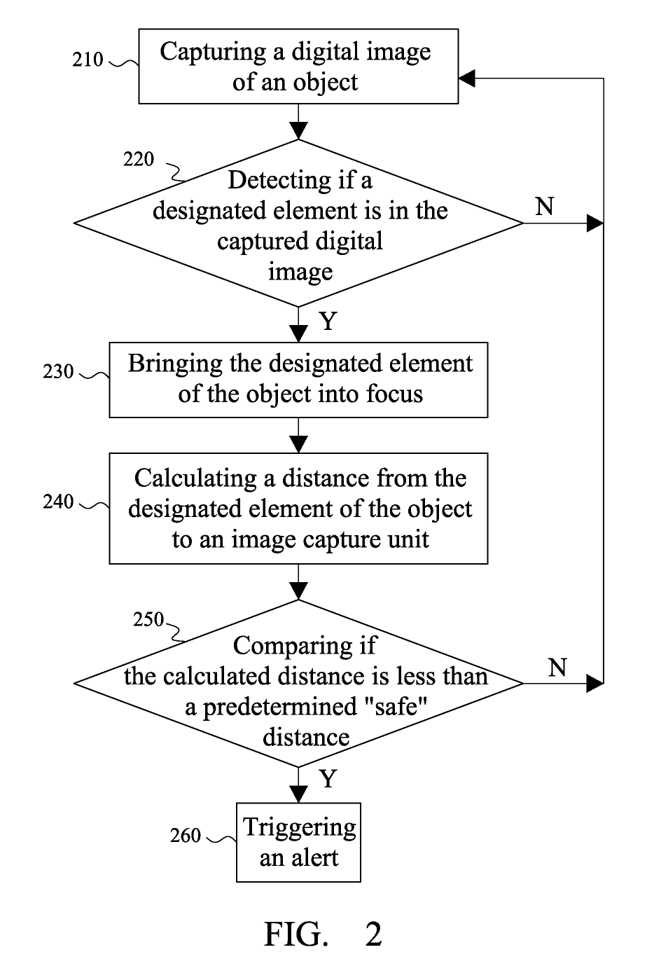

Referring to FIG. 2, an embodiment of a computer alert method for object proximity to the computer is performed by a computer alert system 100. Depending on the embodiment, certain of the steps described below may be removed, others may be added, and the sequence of the steps may be altered.

In step 210, a digital image of an object is captured by an image capture unit 10 installed on a computer (not shown). The image capture unit 10 includes a lens unit 11 and an image detection unit 12. An optical image of the object is captured by the lens unit 11 and the optical image is converted to the digital image by the image detection unit 12. The image detection unit 12 may be a Charge Coupled Device (CCD) image sensor or Complementary Metal-Oxide-Semiconductor (CMOS) image sensor.

In step 220, a designated element of the object is sought. If the designated element is detected, step 230 is executed. If no designated element is detected, step 210 is repeated. In detail, many detection algorithms such as nerve network, nerve network plus fast Fourier transform, fuzzy plus nerve network, RGB normalized color, fuzzy color, principle component analysis, or algorithm template can be used by the element detection unit 20.

In step 230, the designated element of the object is brought into focus, specifically by the lens unit 11 being moved to focus by an autofocus unit 30, which may include a step motor.

In step 240, a distance from the designated element of the object to the image capture unit 10 is calculated. The number of steps is calculated by a calculation formula, such as U=f*(ns+c+n)/(ns+c), where U is a distance from the designated element of the object to the image capture unit 10, n is the number of steps calculated by the calculation unit 40, s is the step distance, c is a constant parameter, and f is focal length as a constant. It is to be noted that the different variable values may be used with different step motors in acquiring the calculated distance from the designated element of the object to the image capture unit 10. In this embodiment, the calculation unit 40 is a counter.

In step 250, the calculated distance and a predetermined “safe” distance are compared. If the calculated distance is less than the predetermined “safe” distance, it is determined that object proximity is unsafe and step 260 is executed. If the calculated distance exceeds the predetermined “safe” distance, step 210 is repeated. In this embodiment, the predetermined “safe” distance measurement stored by a storage unit 70 is preset by the manufacturer or user.

In the step 260, an alert is triggered.

It is to be noted that, in practice, the designated element of the object can be a facial area presented by a computer user, or, alternatively, any other part of the user presented to the image capture unit, or any other part of any other object, so long as the predetermined “safe” distance is based on prior determination thereof, while remaining well within the scope of the disclosure.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A computer alert system for object proximity, comprising:
an image capture unit installed on the computer capable of capturing a digital image of the object;
an element detection unit capable of detecting if a designated element of the object is in the captured digital image;
an autofocus unit capable of focusing on the designated element of the object;
a calculation unit capable of calculating a distance from the designated element of the object to the computer after the designated element is focused on;
a comparison unit capable of determining if the calculated distance is acceptable; and
an alert unit capable of triggering an alert if the calculated distance is not acceptable.

2. The computer alert system of claim 1, wherein the image capture unit comprises a lens unit and an image detection unit, the lens unit presenting an optical image of the object onto the image detection unit, and the image detection unit converting the optical image to a captured digital image.

3. The computer alert system of claim 2, wherein the image detection unit is a charge coupled device image sensor or a complementary metal-oxide-semiconductor image sensor.

4. The computer alert system of claim 1, further comprising a storage unit for storing a predetermined “safe” distance measurement, the comparison unit being capable of comparing the calculated distance with the predetermined “safe” distance.

5. The computer alert system of claim 4, wherein the storage unit is a semiconductor memory, a magnetic random access memory or an electrically-erasable programmable read-only memory.

6. The computer alert system of claim 1, wherein the lens unit is a focusing lens and the autofocus unit is a step motor capable of moving the lens to focus on the object of the digital image.

7. The computer alert system of claim 6, wherein the calculation unit is a counter capable of counting the number of the steps that the lens moves from an origin to a focused position.

8. A computer alert method for object proximity, comprising:
capturing a digital image of the object via an image capturing device installed on the computer;
focusing on a designated element of the captured digital image;
calculating a distance from the designated element of the object to the computer;
determining if the calculated distance is acceptable; and
triggering an alert if the calculated distance is not acceptable.

9. The method of claim 8, wherein the capturing step comprises:
presenting an optical image of the object; and
converting the optical image into a captured digital image.

10. The method of claim 8, further comprising determining if the designated element of the object is in the captured digital image.

11. The method of claim 10, wherein the focusing step is performed if the designated element of the object is in the captured digital image.

12. The method of claim 10, wherein the capturing step is performed if the designated element of the object is not in the captured digital image.

13. The method of claim 10, wherein the designated element of the object is detected by an element detection unit.

14. The method of claim 8, further comprising storing a predetermined “safe” distance measurement.

15. The method of claim 14, wherein the calculated distance is compared with the predetermined “safe” distance.

16. The method of claim 8, wherein the designated element of the object of the digital image is brought into focus through movement of a focusing lens by a step motor.

17. The method of claim 16, wherein a number of steps is counted by moving the focusing lens from the origin to a focused position in the calculating step.

18. The method of claim 10, wherein the step for determining whether the designated element is in the image uses a detection algorithm.

19. The method of claim 18, wherein the detection algorithm is one selected from the group consisting of nerve network, nerve network plus fast Fourier transform, fuzzy plus nerve network, RGB normalized color, fuzzy color, principle component analysis, and algorithm template.
